(19) United States
(12) Patent Application Publication
(10) Pub. No.: US 2005/0190255 A1
(43) Pub. Date: Sep. 1, 2005

(54) Line head and image formation apparatus employing the same

(75) Inventors: Kiyoshi Tsujino, Nagano (JP); Ken Ikuma, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/058,749

(22) Filed: Feb. 14, 2005

(30) Foreign Application Priority Data
Feb. 16, 2004 (JP) P2004-038029
Feb. 16, 2004 (JP) P2004-038030

(51) Int. Cl. G06K 15/00; B41J 2/435

(52) U.S. Cl. 347/224; 358/3.18

(57) ABSTRACT

A line head, includes a plurality of light emitting elements, which are arranged in a line and a controller, which applies constant voltage to the light emitting elements on the basis of gradation data. Correction data for correcting a dispersion of light quantities of the respective light emitting elements are added to the gradation data. Also, the correction data of electric quantity for correcting a dispersion of light quantities of the respective light emitting elements are formed by the gradation data.

### BACKGROUND OF THE INVENTION

The present invention relates to a line head which is constructed so as to have no dispersion in light quantities in a main scan direction, and an image formation apparatus which employs the line head.

There have been developed image formation apparatuses wherein a line head in which a large number of light emitting elements are disposed at one line is employed as an exposure unit. Stated in JP-A-11-138899 is an image formation apparatus wherein an exposure unit is formed in such a way that a light emitting element array which consists of a plurality of light emitting elements is integrated on a single chip. In this example, the single-chip light emitting element arrays of individual colors are formed on a single substrate and are thereafter separated, and the separated arrays are arranged in the developing devices of the respective colors, whereby the dispersion of light emission characteristics is eliminated.

The line head employing the plurality of light emitting elements has the problem that, since a dispersion is involved in the light quantities of the individual light emitting elements, nonuniformity appears in an image. In JP-A63-10293 concerning an LED array drive circuit, therefore, it is stated that the dispersion of the light emitting elements is corrected by changing light emission time periods for individual light emitting element arrays.

The technique stated in JP-A-11-138899 consists in that the single-chip light emitting element arrays are formed on the single substrate, whereupon they are separated. Accordingly, a manufacturing process becomes complicated to incur the problem that the light emitting element arrays which are utilizable are limited. Besides, with the technique stated in JP-A-63-10293, the adjustment magnitudes of the light emission time periods are always identical in the respective light emitting element arrays, and the dispersion among individual dots cannot be corrected. Here in the technique stated in JP-A-63-10293, current feed lines must be laid for the respective dots in order to correct the dispersion among the individual dots. This incurs the problem that a circuit arrangement becomes complicated to make a control difficult.

### SUMMARY OF THE INVENTION

The present invention has been made in view of such problems in the above related techniques, and has for its object to provide a line head and an image formation apparatus which suppress the dispersion of light quantities in a main scan direction and prevent the degradation of an image with a simple construction.

According to the present invention, there is also provided a line head, comprising:
a plurality of light emitting elements, which are arranged in a line; and
a controller, which applies constant voltage to the light emitting elements on the basis of gradation data,
wherein correction data for correcting a dispersion of light quantities of the respective light emitting elements are added to the gradation data.

In the above configuration, the dispersion of the light quantities is corrected by the simple construction that the correction data are merely added to the original gradation data which are fed for controlling the individual light emitting elements. Therefore, the construction of the line head for correcting the dispersion of the light quantities can be simplified.

According to the present invention, there is also provided a line head, comprising:
a plurality of light emitting elements, which are arranged in a line; and
a controller, which applies constant voltage to the light emitting elements on the basis of gradation data, wherein correction data of electric quantity for correcting a dispersion of light quantities of the respective light emitting elements are formed by the gradation data.

In the above configuration, the dispersion of the light quantities is corrected by the simple construction that the correction data of the electric quantity are formed on the basis of the gradation data which are fed to the individual light emitting elements. Therefore, the construction of the line head for correcting the dispersion of the light quantities can be simplified.

Preferably, the line head, further comprising a setting unit which sets the correction data. The setting unit and the light emitting elements are provided on the same substrate. In the above configuration, the light emitting elements and the setting unit are provided on the identical substrate of the line head, so that the space of the line head for which the dispersion of the light quantities is to be corrected can be effectively utilized.

Preferably, the correction data are set for the respective light emitting elements in accordance with deviation amounts of the light emission quantities with respect to a reference light quantity. In the above configuration, the correction data corresponding to the deviation magnitudes of the light emission quantities relative to the reference light quantity are set for the respective light emitting elements, so that the dispersion of the light quantities can be finely corrected.

Preferably, the correction data are stored in the setting unit together with the gradation data in a table format. In the above configuration, any special storage for storing the correction data is not required, so that the effective utilization of memory resources can be achieved.

Preferably, the light emitting elements are configured by organic EL elements. The organic EL elements can be brought into correspondence with the dots of pixels which are to be formed on an image carrier, so that the dispersion of the light quantities can be corrected in dot units, thereby to precisely suppress the degradation of an image quality.

Preferably, the controller is configured by a drive circuit of active matrix scheme which controls the light emitting elements. Therefore, even when each switching TFT disposed in the drive circuit is turned OFF, the operation of the corresponding light emitting element is continued to maintain light emission, and hence, the pixel can be exposed to light at a high brightness.

Preferably, the light quantity control of the light emitting elements is performed by a PWM control. Therefore, the control of each light emitting element based on the gradation data can be precisely performed.

Preferably, the electric quantity is voltage or current. Therefore, the control of each light emitting element can be precisely performed.

Preferably, a plurality of linear arrays of light emitting elements in which each of the linear arrays has the light emitting elements; and
wherein the linear arrays of the light emitting elements are arranged in a sub-scan direction of the line head. In performing multiple exposure, therefore, the dispersion of the light quantities in the main scan direction can be suppressed to prevent the image quality from degrading. According to the present invention, there is also provided an image formation apparatus, comprising:
at least two image forming stations, each including:
   an image carrier;
   a charger, which charges the image carrier, and is located near the image carrier;
   the above line head according for exposing the image carrier; and
   an image transfer, which transfer a toner image to a transfer medium,
wherein the transfer medium is passed through the individual image forming stations so that image formation is performed by a tandem scheme.

In the above configuration, the dispersion of light quantities in a main scan direction can be suppressed to prevent an image quality from degrading.

According to the present invention, there is also provided an image formation apparatus, comprising:
an image carrier, which is configured so as to bear an electrostatic latent image;
a rotary developing unit; and
the above line head for exposing the image carrier,
wherein the rotary developing unit bears toners which is accommodated in a plurality of toner cartridges, on its surface, and rotates in a predetermined rotating direction so as to successively convey the toners of different colors to a position opposing to the image carrier; and
wherein the rotary developing unit applies developing bias between the image carrier and the rotary developing unit so that the toners are moved from the rotary developing unit to the image carrier, whereby the electrostatic latent images are developed to form a toner image.

In the above configuration, the dispersion of light quantities in a main scan direction can be suppressed to prevent an image quality from degrading.

Preferably, the image formation apparatus further comprises an intermediate transfer member. In the above configuration, the dispersion of light quantities in a main scan direction can be suppressed to prevent an image quality from degrading.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a control unit for the line head of the present invention;

FIG. 2 is a graph showing the characteristics of light emitting elements;

FIG. 3 is a graph showing the characteristics of light emitting elements;

FIG. 4 is a graph showing the characteristics of light emitting elements;

FIG. 5 is an explanatory diagram showing an example of gradation data;

FIG. 6 is an explanatory diagram showing an example of gradation data;

FIG. 7 is an explanatory diagram showing an example of gradation data;

FIG. 8 is an explanatory diagram showing the relationship between bit data and gradation data;

FIG. 9 is a block diagram of an example in which light emitting elements are subjected to a PWM control;

FIG. 10 is an explanatory diagram of an example in which the light emitting element is subjected to the PWM control;

FIG. 11 is a circuit diagram of an active matrix scheme;

FIG. 12 is an explanatory diagram of the invention;

FIG. 13 is a block diagram showing a control unit for the line head of the present invention;

FIG. 14 is a graph showing the characteristics of light emitting elements;

FIG. 15 is a graph showing the characteristics of light emitting elements;

FIG. 16 is a graph showing the characteristics of light emitting elements;

FIG. 17 is an explanatory diagram showing an example of gradation data;

FIG. 18 is an explanatory diagram showing an example of gradation data;

FIG. 19 is an explanatory diagram showing an example of gradation data;

FIG. 20 is an explanatory diagram showing the relationship between bit data and gradation data;

FIG. 21 is a block diagram of an example in which light emitting elements are controlled by electric quantities;

FIG. 22 is an explanatory diagram of an example in which the light emitting element is subjected to a gradation control;

FIG. 23 is a circuit diagram of an active matrix scheme;

FIG. 24 is a side view showing an image formation apparatus of tandem scheme;

FIG. 25 is a side view showing an image formation apparatus of tandem scheme;

FIG. 26 is a side view showing an image formation apparatus of rotary scheme; and

FIG. 27 is an explanatory diagram showing an example of a line head.

### DETAILED DESCRIPTION OF THE PREFERRED EMBODIMENTS

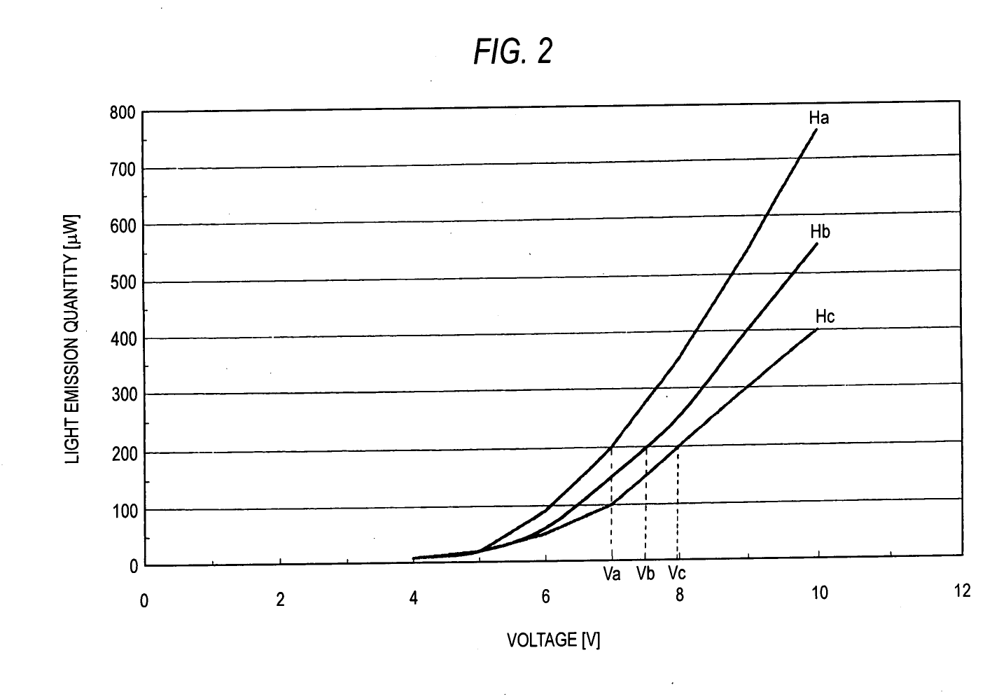

Now, the present invention will be described with reference to the drawings. FIG. 2 to FIG. 4 are graphs for explaining techniques on which the invention is premised, and they show an example in which organic EL elements are employed as light emitting elements. FIG. 2 shows the voltage—light quantity characteristics of the light emitting elements Ha, Hb and Hc. As shown in FIG. 2, even when an identical voltage is applied, the light quantities of the respective light emitting elements Ha—Hc are different. In other words, voltages to be applied for obtaining an identical light quantity are different for the respective light emitting elements. By way of example, in order to obtain a light quantity of 200 (μW/cm²), a voltage of Va (V) is applied to the light emitting element Ha, a voltage of Vb (V) to the light emitting element Hb, and a voltage of Vc (V) to the light emitting element Hc.

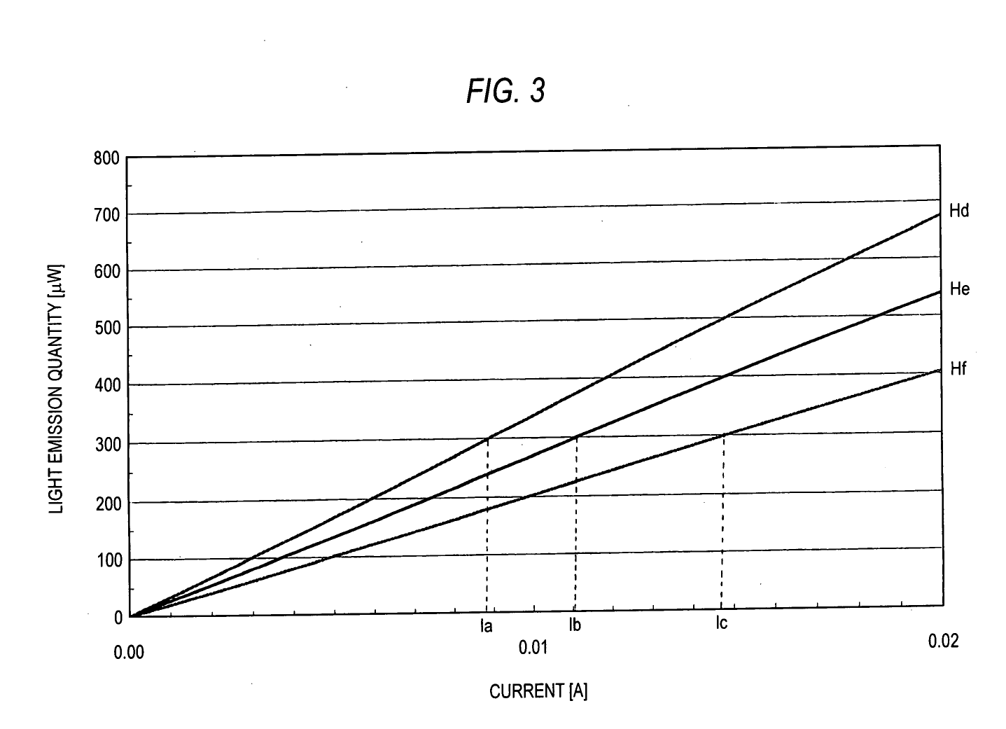

FIG. 3 shows the current—light quantity characteristics of light emitting elements Hd, He and Hf. As shown in FIG. 3, even when an identical current is fed to the light emitting elements, the light quantities of the respective light emitting elements Hd—Hf are different. In other words, currents to be fed for obtaining an identical light quantity are different for the respective light emitting elements. By way of example, in order to obtain a light quantity of 300 (μW/cm²), a current of la (A) is fed to the light emitting element Hd, a current 1b (A) to the light emitting element He, and a current Ic (A) to the light emitting element Hf.

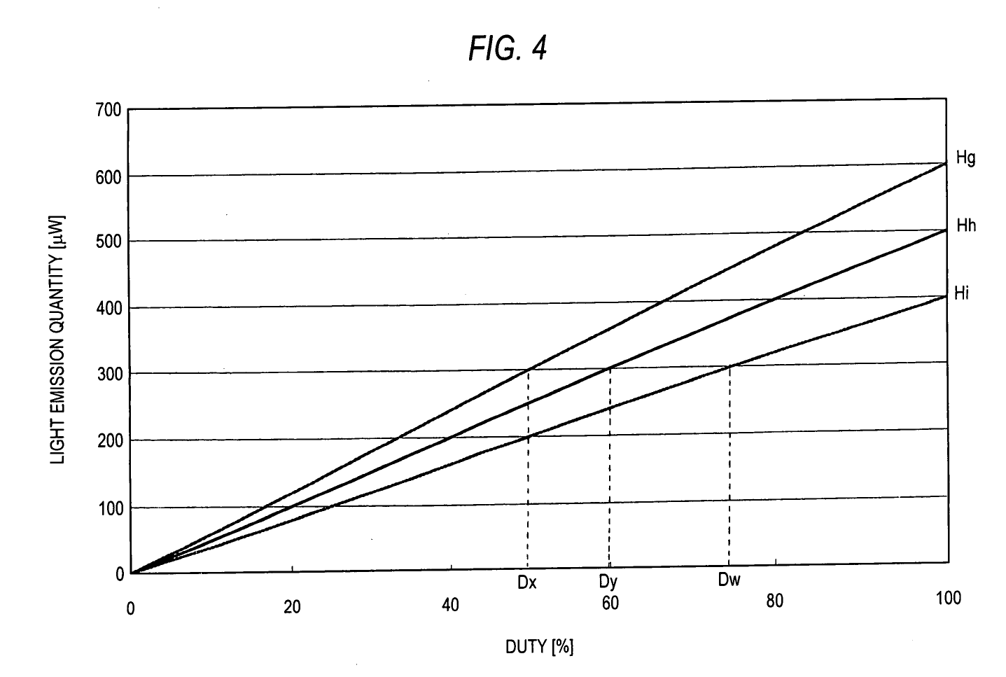

FIG. 4 shows the duty—light quantity characteristics of light emitting elements Hg, Hh and Hi. In this example, duties in the case of subjecting the light emitting elements to a pulse width modulation control (PWM control) are indicated. As explained in conjunction with FIG. 2 or FIG. 3, even when the identical voltage is applied or when the identical current is fed, the light quantities of the respective light emitting elements are different, so that when the light emitting elements are driven at an identical duty, the light quantities of the respective light emitting elements Hg—Hi are different. By way of example, in order to obtain the light quantity of 300 (μW/cm²), the duty of the light emitting element Hg is set at Dx %, that of the light emitting element Hh is set at Dy %, and that of the light emitting element Hi is set at Dw %. Since the light quantities of the respective light emitting elements corresponding to the identical duty are different in this manner, image nonuniformity appears.

In a line head wherein a plurality of light emitting elements are arrayed at one line in a main scan direction and are subjected to a constant-voltage control, the individual light emitting elements are sometimes controlled on the basis of gradation data in accordance with the PWM control. On this occasion, there is the problem that, since the individual light emitting elements have the duty—light quantity characteristics as shown in FIG. 4, the image nonuniformity appears as stated before.

FIG. 12 is an explanatory diagram showing the fundamental of the invention. In an embodiment of the invention, in the case of subjecting the light emitting elements to the PWM control, correction data are added to the gradation data, thereby to correct the dispersion of the light quantities. In FIG. 12, a pulse width Wy (duty ratio Wy/Ws) for a smaller light quantity (−) and a pulse width Wz (duty ratio Wz/Ws) for a larger light quantity (+) are shown with respect to the pulse width Wx (duty ratio Wy/Ws) of a reference light quantity at gradation data Dp.

The correction data which decreases the gradation data is added to the light emitting element whose light quantity is larger than the reference light quantity, so as to bring the duty ratio into agreement with that of the reference light quantity. Besides, the correction data which increases the gradation data is added to the light emitting element whose light quantity is smaller than the reference light quantity, so as to bring the duty ratio into agreement with that of the reference light quantity. In the invention, the dispersion of the light quantities is corrected by making such adjustments of the duty ratios.

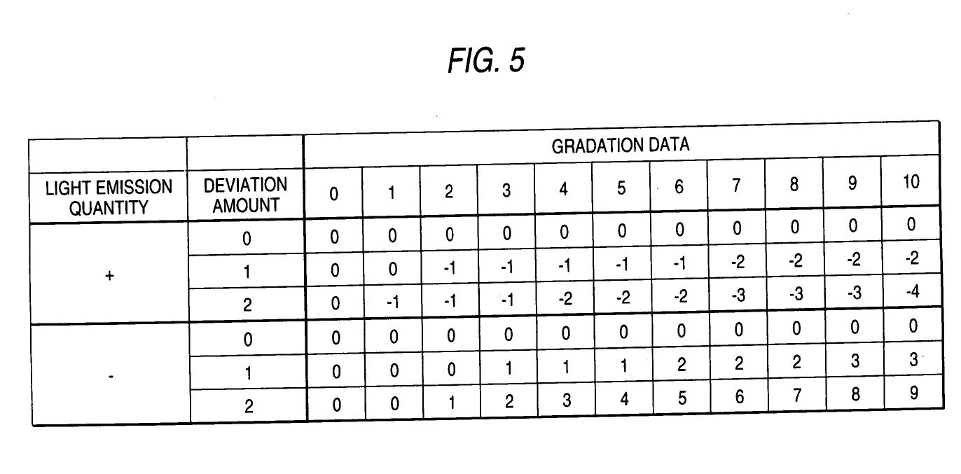

FIG. 5 to FIG. 7 are explanatory diagrams showing examples of tables for storing gradation data and correction data. FIG. 5 is the example of the table which represents the increments and decrements of the gradation data in individual light emitting elements, in the case where the gradation data of a light emitting element of reference light emission quantity are set at “0”-“10”. The light emitting elements whose light emission quantities are larger than the reference light emission quantity are denoted by “+”, whereas the light emitting elements whose light emission quantities are smaller than the reference light emission quantity are denoted by “−”. Each of the light emission quantities “+” and “−” is classified into the three levels of “0”, “1” and “2” in accordance with the deviation magnitudes of the light emission quantities relative to the reference light emission quantity.

In the example of FIG. 5, in an exemplary case where the gradation data is “5” in the light emitting element whose light emission quantity relative to the reference light emission quantity has a deviation magnitude “+2”, the increment or decrement is “−2” in view of this table. Accordingly, the gradation data of “3” is sent to the pertinent light emitting element. The PWM control for the pertinent light emitting element is performed on the basis of the corrected gradation data, namely, the corrected duty ratio, thereby to perform a light quantity control for bringing the light emission quantity into agreement with the reference light quantity. In this manner, in the example of FIG. 5, the dispersion of the light quantities is corrected by the simple construction in which the correction data are merely added to the original gradation data that are fed for controlling the individual light emitting elements. Therefore, the construction of the line head for correcting the dispersion of the light quantities can be simplified.

In FIG. 5, the correction data corresponding to the deviation magnitudes relative to the reference light quantity are set for the respective light emitting elements, and hence, the dispersion of the light quantities can be finely corrected. Besides, the correction data which are set for the respective light emitting elements are stored together with the gradation data, in the table format as shown in FIG. 5. Therefore, any special storage for storing the correction data is not required, so that the effective utilization of memory resources can be achieved.

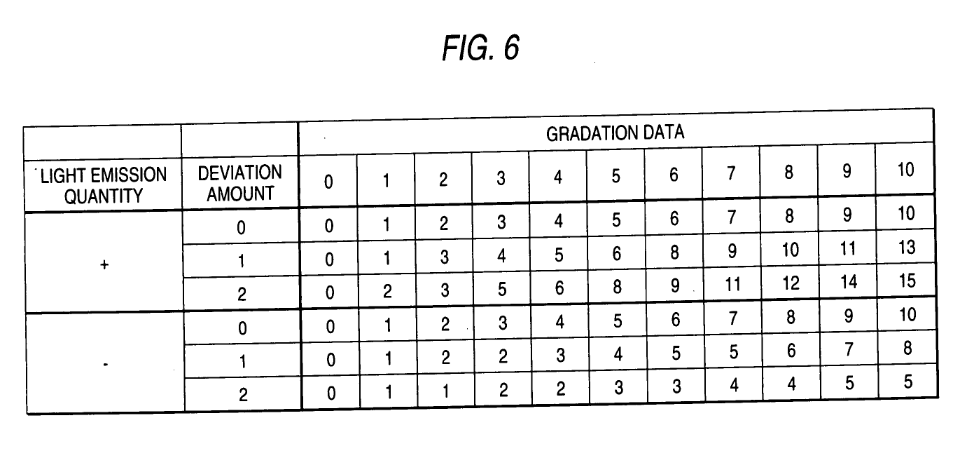

FIG. 6 shows the table indicating the light emission quantities of the individual light emitting elements in the case where the corrections of the gradation data as stated above are not made. In FIG. 6, the light emission quantities are normalized and represented with reference to a light quantity at the gradation “1” of the reference light emitting element. In this case, assuming by way of example that the gradation data of the reference light emission quantity be “5”, the deviation of the light emission quantity disperses within a range of “+3”-“−2”. Such differences in the light emission quantity appear as the nonuniformities of an image, and a print quality degrades.

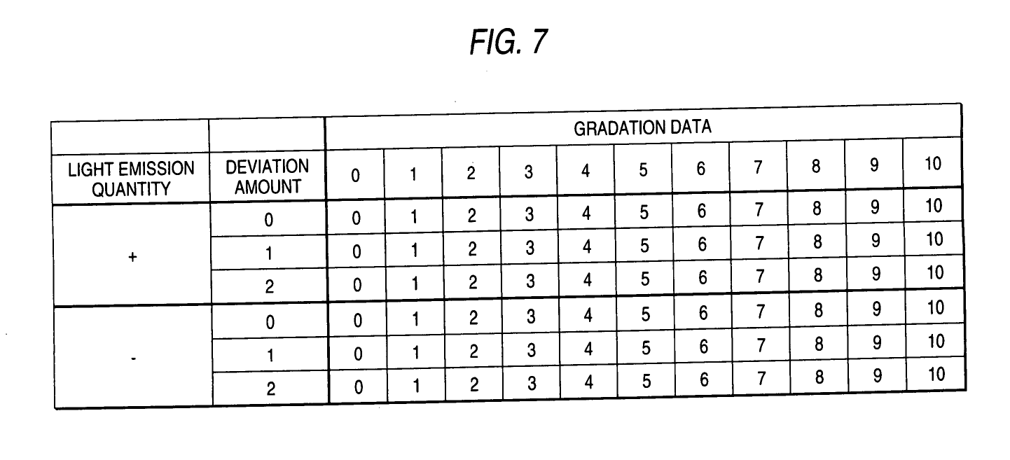

FIG. 7 shows the table indicating the light emission quantities of the individual elements in the case where the corrections of the gradation data have been made. In FIG. 7, in the exemplary case where the gradation data of the reference light emission quantity is “5”, the light emission quantities of the individual light emitting elements are corrected and become the same even when the deviations of the light emission quantities disperse within a range of “+2”−“−2”. In this manner, in the case where the identical gradation data are fed to the respective light emitting elements, the light emission quantities become the same even when the dispersion is involved in the light emission quantities of the respective light emitting elements. Therefore, the nonuniformities of the image do not appear, and the print quality can be prevented from degrading.

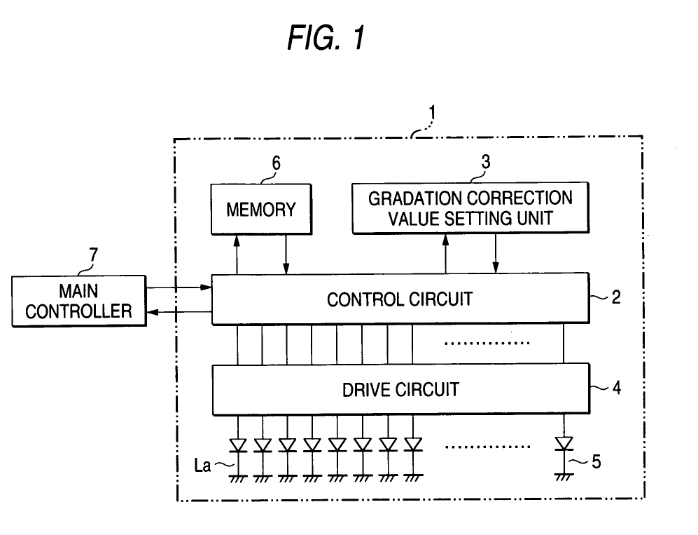

FIG. 1 is a block diagram showing the schematic construction of an image formation apparatus. Referring to FIG. 1, numeral 1 designates a control unit for a line head, numeral 2 designates a control circuit, numeral 3 designates a gradation correction value setting unit, numeral 4 a drive circuit which is constituted by TFTs, numeral 5 designates a light emitting element line at which a plurality of light emitting elements La are arrayed at one line, numeral 6 designates a memory, and numeral 7 designates a main controller. The gradation correction value setting unit 3 is provided on the same substrate as that of the light emitting elements La.

The main controller 7 forms print data and sends them to the control unit 1 of the line head. The memory 6 stores therein image data which correspond to the light emitting element lines of individual colors. The gradation correction value setting unit 3 stores therein the light emission quantities of individual light emitting elements, and tables for correcting gradation data which correspond to the light emission quantities. Besides, the gradation correction value setting unit 3 forms the correction data as explained in conjunction with FIG. 5 on the basis of the gradation data transmitted from the main controller 7. The control circuit 2 forms control signals for the individual light emitting elements on the basis of the correction data to operate the drive circuit 4 by the control signals, thereby to perform the light quantity controls of the respective light emitting elements.

In FIG. 1, the setting unit for setting the correction data, that is the light emitting elements La and the gradation correction value setting unit 3, are provided on the same substrate as that of the line head, so that the space of the line head for which the dispersion of light quantities is to be corrected can be effectively utilized. Besides, in FIG. 1, organic EL elements are employed as the light emitting elements La. Since the organic EL elements can be arranged in correspondence with the dots of pixels to be formed on an image carrier, the degradation of an image quality can be precisely suppressed by correcting the dispersion of the light quantities in dot units.

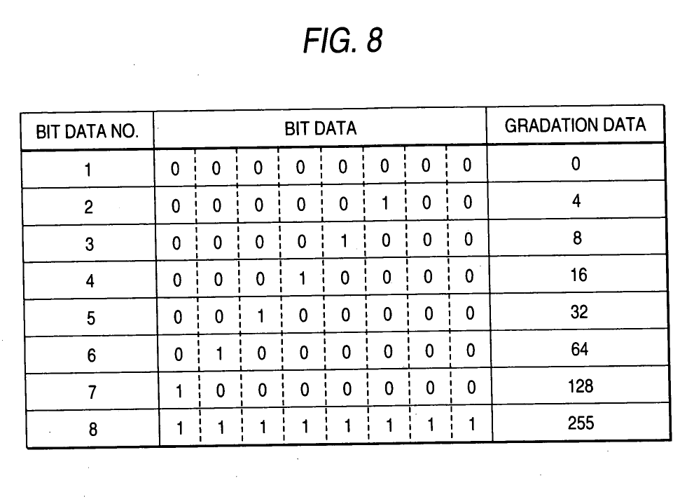

FIG. 8-FIG. 10 are diagrams for explaining examples in which light emitting elements are controlled by gradation data according to the invention. FIG. 8 is the explanatory diagram showing the example of bit data and the gradation data which are stored in a gradation data memory. In this example, the gradation data are stored in the gradation data memory of 8 bits. In the example of FIG. 8, gradation data 0 (non-luminescence) is set by bit data No. 1, data of the highest density is set by bit data No. 8, and density data of intermediate gradations are set by bit data Nos. 2-7.

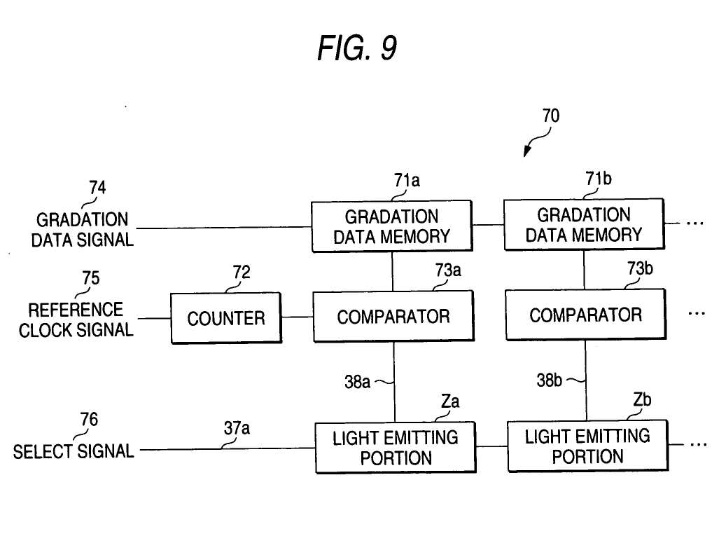

FIG. 9 is the block diagram showing the example which performs the PWM control. Referring to FIG. 9, a PWM control unit 70 includes gradation data memories 71a, 71b, which are constructed of shift registers or the likes, a counter 72, comparators 73a, 73b, . . . , and light emitting portions Za, Zb, . . . . The gradation data memories 71a, 71b, are fed with a gradation data signal 74 from, for example, the main controller 7 shown in FIG. 1. The number of bits of each of the gradation data memories 71a, 71b, . . . is set at 8 bits as shown in FIG. 8. The counter 72 counts reference clock signals 75.

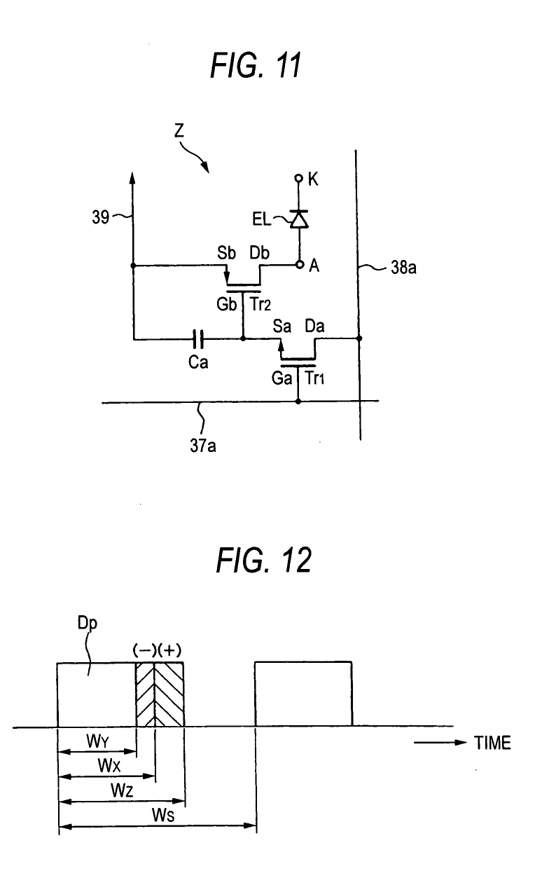

The number of bits of the counter 72 is the same 8 bits as the number of bits of each of the gradation data memories 71a, 71b, . . . . The count value of the counter 72 iterates 0→maximum value (255)→0→maximum value. The comparators 73a, 73b, compare the signal of the counter 72 with the gradation data stored in the gradation data memories 71a, 71b, . . . . When (gradation data)>(counter value) holds, a switching TFT shown in FIG. 11 is turned ON. Besides, when (gradation data)<(counter value) holds, the switching TFT is turned OFF.

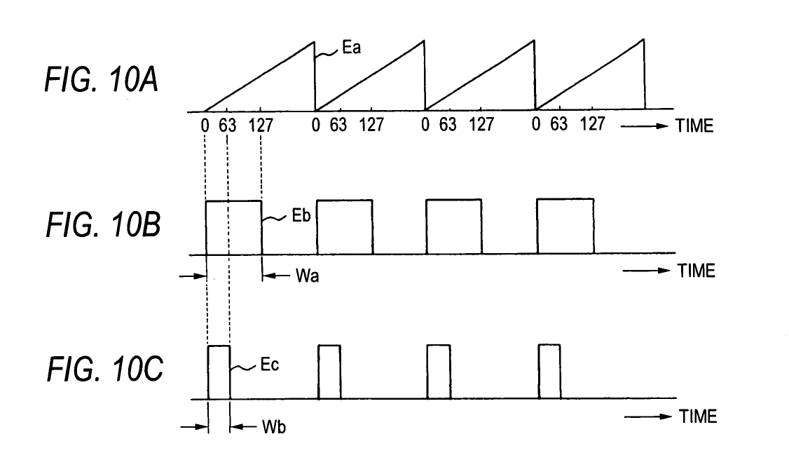

FIG. 10 is the graph showing the practicable example of the PWM control which is illustrated by the block diagram of FIG. 9. FIG. 10A shows the output value Ea of the counter 72, and this output value iterates 0→maximum value (255)→0→maximum value→0 . . . as stated before. FIG. 10B shows the waveform Eb of a signal which is outputted from the comparator, in other words, the operating characteristic of the switching TFT, in the case where the gradation data is the bit data No. 7 (128th gradation level). In this case, the switching TFT is turned ON in a range in which the output of the counter 72 is 0-127, and it is turned OFF in a range in which the output of the counter 72 is 128-255.

FIG. 10C shows the waveform Ec of a signal which is outputted from the comparator, in other words, the operating characteristic of the switching TFT, in the case where the gradation data is the bit data No. 6 (64th gradation level). In this case, the switching TFT is turned ON in a range in which the output of the counter 72 is 0-63, and it is turned OFF in a range in which the output of the counter 72 is 64-255.

In the case of FIG. 10B, the pulse width of the waveform Eb is Wa, whereas in the case of FIG. 1 ° C., the pulse width of the waveform Ec is Wb. That is, the length of a time period for which the switching TFT is turned ON differs in accordance with the magnitude of the gradation data, so that the light emission quantity of the light emitting element can be changed. In this manner, an exposure quantity for the image carrier can be changed by turning ON and OFF the light emitting element through the ON/OFF control of the switching TFT, and hence, the circuit arrangement can be simplified. Besides, the control of the individual light emitting elements based on the gradation data can be precisely performed by the PWM control.

FIG. 11 is a circuit diagram for operating the light emitting portion Z shown in FIG. 9, by an active matrix. Referring to FIG. 11, an organic EL element is used as a light emitting element, and it has a cathode terminal K and an anode terminal A. The cathode terminal K is connected to a power source not shown. Sign 37a designates a scan line, which is connected to the gate Ga of the switching TFT (Tr1). Besides, sign 38a designates a signal line, which is connected to the drain Da of the switching TFT. Numeral 39 designates a power source line, and sign Ca a storage capacitor. The source Sb of a driving TFT (Tr2) for the organic EL element is connected to the power source line 39, and the drain Db thereof to the anode terminal A of the organic EL element. Further, the gate Gb of the driving TFT is connected to the source Sa of the switching TFT.

Next, the operation of the circuit diagram in FIG. 11 will be described. When the scan line 37a and the signal line 38a are energized in a state where the voltage of the power source line 39 is applied to the source of the switching TFT, this switching TFT turns ON. Therefore, the gate voltage of the driving TFT lowers, the voltage of the power source 39 is fed through the source of the driving TFT, and this driving TFT is rendered conductive. As a result, the organic EL element operates to emit light in a predetermined light quantity. Besides, the storage capacitor Ca is charged by the voltage of the power source line 39.

Even in a case where the switching TFT has been turned OFF, the driving TFT is held in its conductive state on the basis of charges stored in the storage capacitor Ca, and the organic EL element maintains its light emission state. In the case of applying the active matrix to the drive circuit of the light emitting elements, accordingly, even when the switching TFT is turned OFF in order to shift the image data by the shift register, the operation of the organic EL element continues to keep the light emission, and the pixel can be exposed to the light at a high brightness.

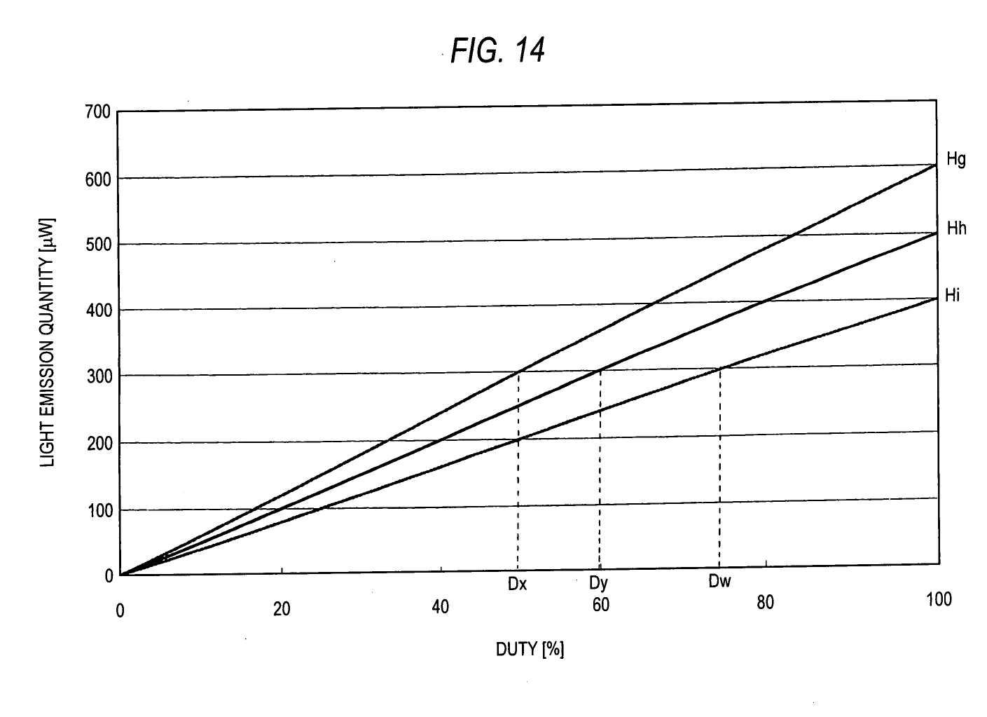

Next, a second embodiment will be described with reference to the drawings. FIG. 14-FIG. 16 are graphs for explaining techniques on which the invention is premised, and they show an example in which organic EL elements are employed as light emitting elements. FIG. 14 shows the duty—light quantity characteristics of light emitting elements Hg, Hh and Hi. In this example, duties in the case of controlling the light emitting elements by gradation data are indicated. Even when an identical voltage is applied or when an identical current is fed, the light quantities of the respective light emitting elements are different, so that when the light emitting elements are controlled at an identical duty ratio, the light quantities of the respective light emitting elements Hg—Hi are different. By way of example, in order to obtain the light quantity of 300 (μW/cm²), the duty of the light emitting element Hg is set at Dx %, that of the light emitting element Hh is set at Dy %, and that of the light emitting element Hi is set at Dw %. Since the light quantities of the respective light emitting elements corresponding to the identical duty ratio are different in this manner, image nonuniformity appears.

FIG. 24 is an explanatory diagram showing the fundamental of the invention. In this embodiment of the invention, in the case of controlling the light emitting elements on the basis of gradation data, correction data of electric quantity are formed from the gradation data, thereby to correct the dispersion of the light quantities. In FIG. 24, a pulse width Wy (duty ratio Wy/Ws) for a smaller duty ratio (−) and a pulse width Wz (duty ratio Wz/Ws) for a larger duty ratio (+) are shown with respect to the pulse width Wx (duty ratio W×/Ws) of a reference light quantity at gradation data Dp.

The correction data of the electric quantity is formed for the light emitting element whose light quantity is larger than the reference light quantity, so as to bring the light quantity into agreement with the reference light quantity. Besides, the correction data of the electric quantity is formed for the light emitting element whose light quantity is smaller than the reference light quantity, so as to bring the light quantity into agreement with the reference light quantity. The correction data is formed as the electric quantity of a voltage or current for the pertinent light emitting element. In the graph of FIG. 24, for example, assuming the light emitting element of the reference light quantity be Hh, the duty ratio of this light emitting element Hh is Dy, and the pulse width thereof corresponds to Wx in FIG. 24.

It is accordingly understood that the light emitting element whose duty ratio is smaller than a reference in FIG. 24 has the light quantity characteristic as exhibited by the light emitting element Hg in FIG. 24, whereas the light emitting element whose duty ratio is larger than the reference has the light quantity characteristic as exhibited by the light emitting element Hi in FIG. 24. In the invention, the correction data of the light quantity are formed on the basis of the gradation data in order to bring the light quantity characteristics of such light emitting elements Hg and Hi into agreement with the reference light characteristic.

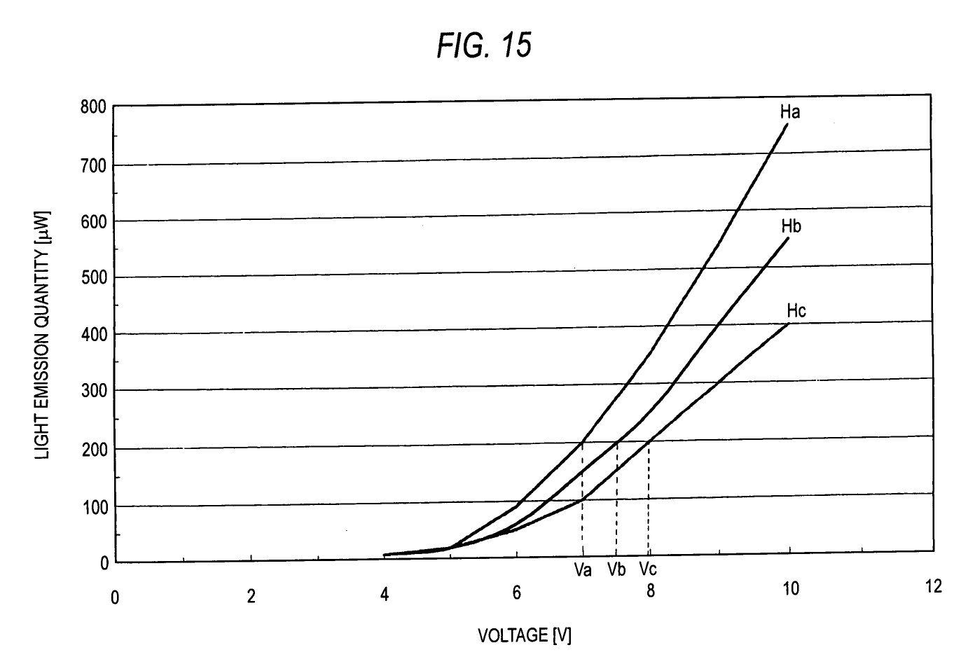

FIG. 15 shows the voltage—light quantity characteristics of light emitting elements Ha, Hb and Hc. As shown in FIG. 15, even when an identical voltage is applied, the light quantities of the respective light emitting elements Ha—Hc are different. In other words, voltages to be applied for obtaining an identical light quantity are different for the respective light emitting elements. It is assumed by way of example that the reference light quantity of 300 (μW/cm²) be obtained when a voltage Vb (V) is applied to the light emitting element Hb. In this case, the correction data are formed so as to attain the reference light quantity by applying a voltage Va (V) to the light emitting element Ha, and a voltage Vc (V) to the light emitting element Hc.

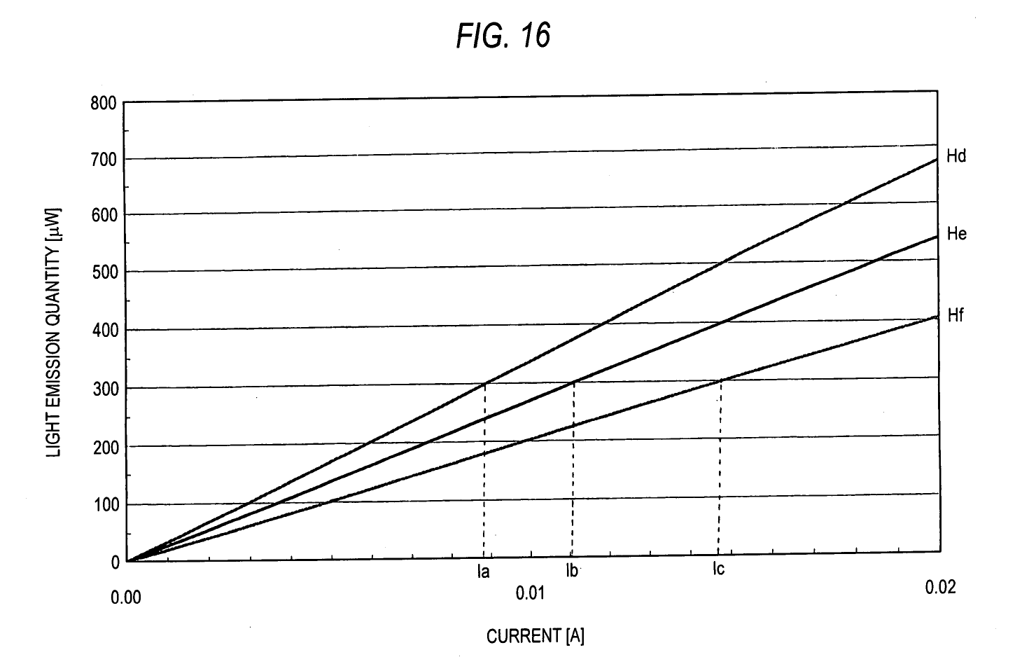

FIG. 16 shows the current—light quantity characteristics of light emitting elements Hd, He and Hf. As shown in FIG. 16, even when an identical current is fed to the light emitting elements, the light quantities of the respective light emitting elements Hd—Hf are different. In other words, currents to be fed for obtaining an identical light quantity are different for the respective light emitting elements. It is assumed by way of example that the reference light quantity of 300 (μW/cm²) be obtained when a current 1b is fed to the light emitting element He. In this case, the correction data are formed so as to attain the reference light quantity by feeding a current 1a (A) to the light emitting element Hd, and a current Ic (A) to the light emitting element Hf.

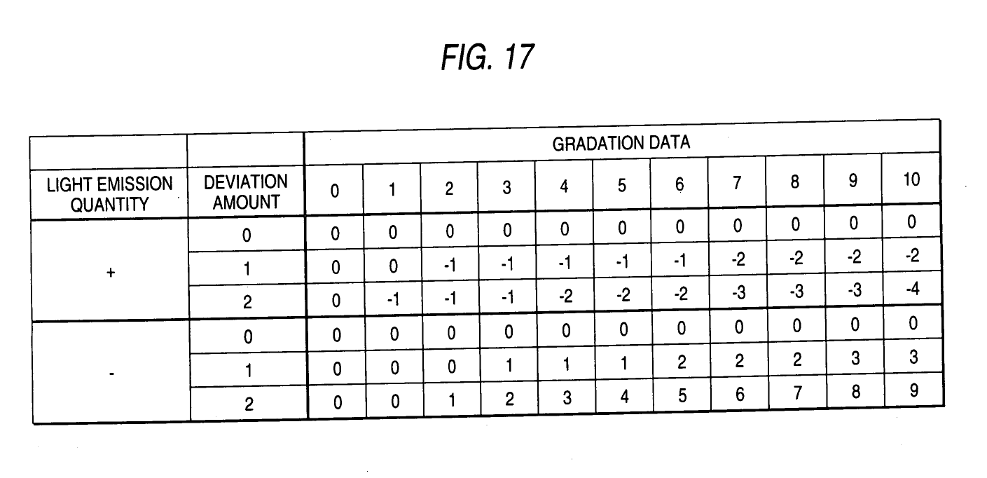

FIG. 17 to FIG. 19 are explanatory diagrams showing examples of tables for storing gradation data and correction data. FIG. 17 is the example of the table which represents the increments and decrements of the correction data of the electric quantity in individual light emitting elements, in the case where the gradation data of a light emitting element of reference light emission quantity are set at “0”-“10”. The light emitting elements whose light emission quantities are larger than the reference light emission quantity are denoted by “+”, whereas the light emitting elements whose light emission quantities are smaller than the reference light emission quantity are denoted by “−”. Each of the light emission quantities “+” and “−” is classified into the three levels of “0”, “1” and “2” in accordance with the deviation magnitudes of the light emission quantities relative to the reference light emission quantity.

In the example of FIG. 17, in an exemplary case where the gradation data is “5” in the light emitting element whose light emission quantity relative to the reference light emission quantity has a deviation magnitude “+2”, the increment or decrement is “−2” in view of this table. Accordingly, the gradation data of “3” is sent to the pertinent light emitting element. The control for the pertinent light emitting element is performed by the electric quantity based on the corrected gradation data, thereby to perform a light quantity control for bringing the light emission quantity into agreement with the reference light quantity. In this manner, in the example of FIG. 17, the dispersion of the light quantities is corrected by the simple construction in such a way that the correction data of the electric quantity are formed on the basis of the gradation data which are fed for controlling the individual light emitting elements. Therefore, the construction of the line head for correcting the dispersion of the light quantities can be simplified.

In the example of FIG. 17, the correction data corresponding to the deviation magnitudes of the light emission quantities relative to the reference light quantity are set for the respective light emitting elements, and hence, the dispersion of the light quantities can be finely corrected. Besides, the correction data which are set for the respective light emitting elements are stored together with the gradation data, in the table format as shown in FIG. 17. Therefore, any special storage for storing the correction data is not required, so that the effective utilization of memory resources can be achieved.

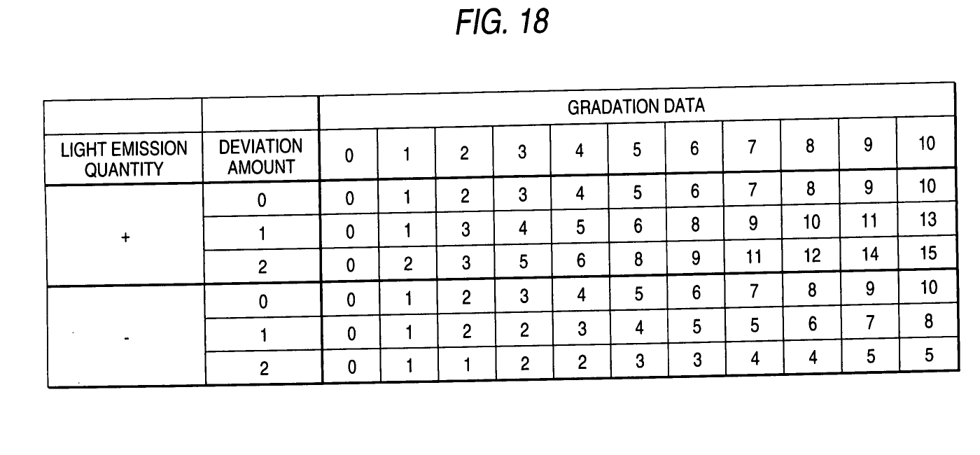

FIG. 18 is the table showing the light emission quantities of the individual light emitting elements in the case where the corrections of the gradation data as stated above are not made. In FIG. 18, the light emission quantities are normalized and represented with reference to a light quantity at the gradation “1” of the reference light emitting element. In this case, assuming by way of example that the gradation data of the reference light emission quantity be “5”, the deviation of the light emission quantity disperses within a range of “+3”-“−2”. Such differences in the light emission quantity appear as the nonuniformities of an image, and a print quality degrades.

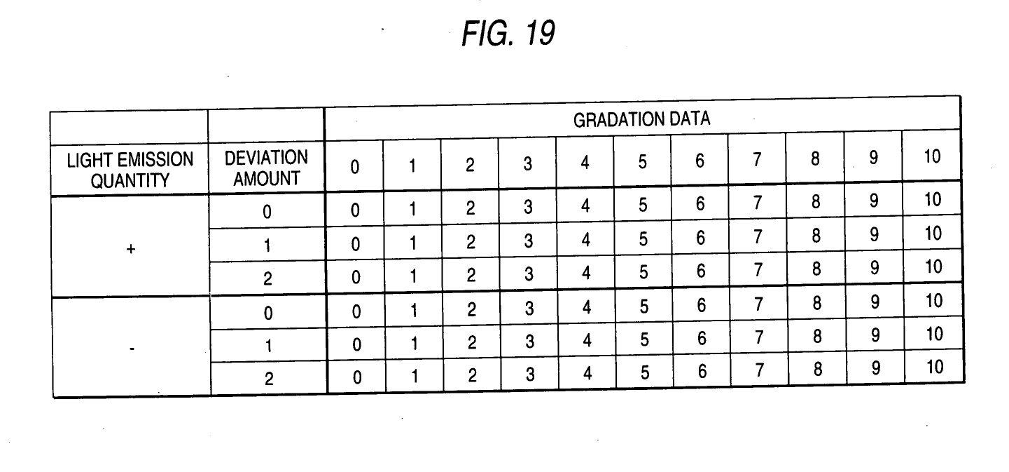

FIG. 19 is the table showing the light emission quantities of the individual elements in the case where the corrections of the gradation data have been made. In the example of FIG. 19, in the exemplary case where the gradation data of the reference light emission quantity is “5”, the light emission quantities of the individual light emitting elements are corrected and become the same even when the deviations of the light emission quantities disperse within a range of “+2”-“−2”. In this manner, in the case where the identical gradation data are fed to the respective light emitting elements, the light emission quantities become the same even when the dispersion is involved in the light emission quantities of the respective light emitting elements. Therefore, the nonuniformities of the image do not appear, and the print quality can be prevented from degrading.

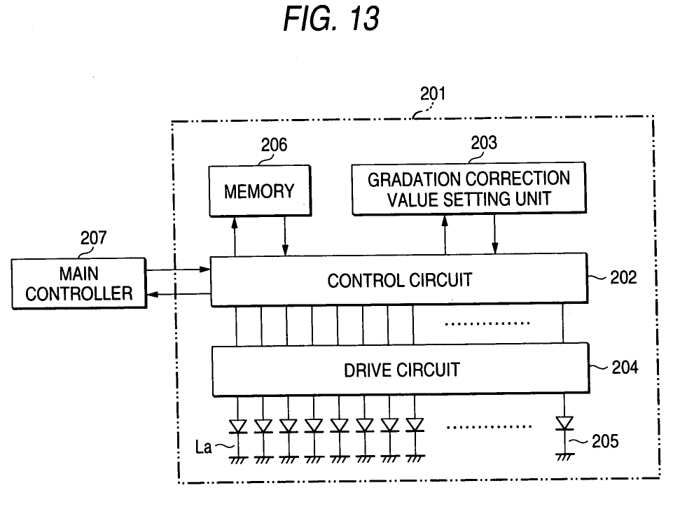

FIG. 13 is a block diagram showing the schematic construction of an image formation apparatus. Referring to FIG. 13, numeral 201 designates a control unit for a line head, numeral 202 designates a control circuit, numeral 203 designates a gradation correction value setting unit, numeral 4 designates a drive circuit which is constituted by TFTs, numeral 5 designates a light emitting element line at which a plurality of light emitting elements La are arrayed at one line, numeral 6 designates a memory, and numeral 7 designates a main controller. The gradation correction value setting unit 203 is provided on the same substrate as that of the light emitting elements La.

The main controller 207 forms print data and sends them to the control unit 201 of the line head. The memory 206 stores therein image data which correspond to the light emitting element lines of individual colors. The gradation correction value setting unit 203 stores therein the light emission quantities of individual light emitting elements, and the tables of gradation data as correspond to the light emission quantities. Besides, the correction data as explained in conjunction with FIG. 17 are created on the basis of the gradation data from the main controller 207. Control signals for the individual light emitting elements are formed on the basis of the correction data by the control circuit 202, and the drive circuit 204 is operated by the control signals, thereby to perform the light quantity controls of the respective light emitting elements.

In the example of FIG. 13, a setting unit for setting the correction data, that is, the light emitting elements La and the gradation correction value setting unit 203, is provided on the same substrate as that of the line head, so that the space of the line head for which the dispersion of light quantities is to be corrected can be effectively utilized. Besides, in the example of FIG. 13, organic EL elements are employed as the light emitting elements La. Since the organic EL elements can be arranged in correspondence with the dots of pixels to be formed on an image carrier, the degradation of an image quality can be precisely suppressed by correcting the dispersion of the light quantities in dot units.

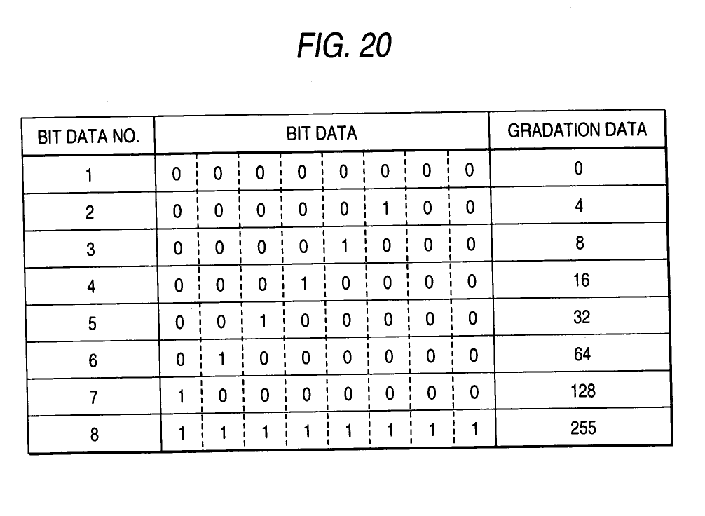

FIG. 20 to FIG. 22 are diagrams for explaining examples in which light emitting elements are controlled by gradation data according to the invention. FIG. 20 is the explanatory diagram showing the example of bit data and the gradation data which are stored in a gradation data memory. In this example, the gradation data are stored in the gradation data memory of 8 bits. In the example of FIG. 20, gradation data 0 (non-luminescence) is set by bit data No. 1, data of the highest density is set by bit data No. 8, and density data of intermediate gradations are set by bit data Nos. 2-7.

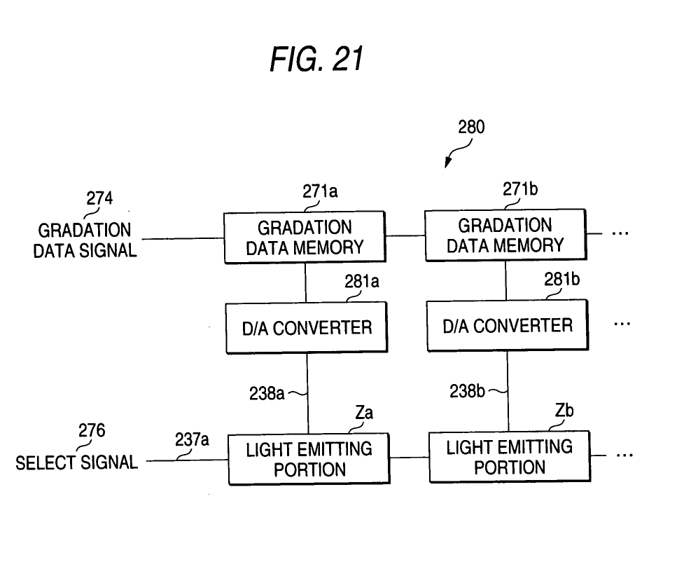

FIG. 21 shows the block diagram according to the invention. The construction in FIG. 21 consists in that switching TFTs are controlled by the electric quantities of voltages or currents corresponding to the magnitudes of the gradation data. An electric-quantity control unit 280 shown in FIG. 21 have D/A converters 281a, 281b, connected to gradation data memories 271a, 271b, . . . , respectively. The D/A converters 281a, 281b, . . . form analog voltage values or current values in the magnitudes which correspond to the gradation data stored in the gradation data memories 271a, 271b, . . . , and they output the formed values to the switching TFTs.

Light emitting portions Za, Zb, are fed with a select signal 276 from a scan line 237a, and control signals from corresponding light emission control data lines 238a, 238b, . . . , respectively. In the example of FIG. 21, the biases of the switching TFTs are changed in accordance with the gradation data, thereby to change the light emission quantities of the light emitting elements. Therefore, the light emitting elements need not be ON/OFF-controlled at high speed, and exposure quantities for the image carrier can be changed at high speed even in a case where the response rates of the light emitting elements are low.

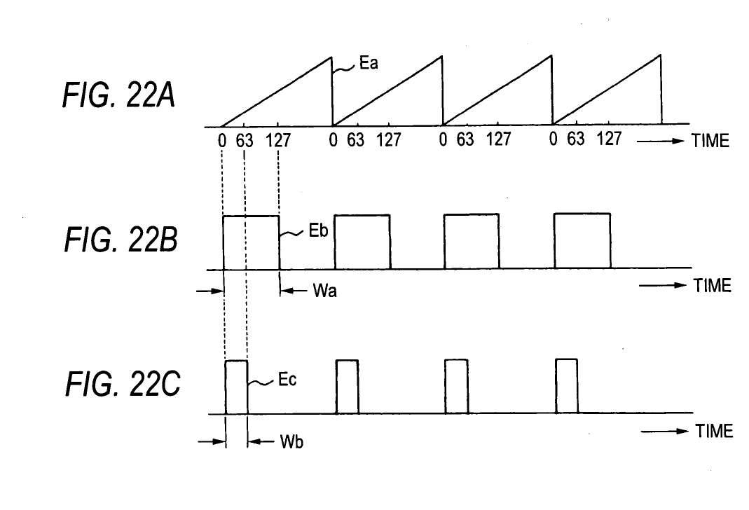

FIG. 22 is the graph showing the practicable example of the control which is illustrated by the block diagram of FIG. 21. FIG. 22A shows the output value Ea of a counter 72, and this output value iterates 0→maximum value (255)→0→maximum value→0 . . . as stated before. FIG. 22B shows the waveform Eb of a signal which is outputted from the comparator, in other words, the operating characteristic of the switching TFT, in the case where the gradation data is the bit data No. 7 (128th gradation level). In this case, the switching TFT is turned ON in a range in which the output of the counter is 0-127, and it is turned OFF in a range in which the output of the counter is 128-255.

FIG. 22C shows the waveform Ec of a signal which is outputted from the comparator, in other words, the operating characteristic of the switching TFT, in the case where the gradation data is the bit data No. 6 (64th gradation level). In this case, the switching TFT is turned ON in a range in which the output of the counter is 0-63, and it is turned OFF in a range in which the output of the counter is 64-255.

In the case of FIG. 22B, the pulse width of the waveform Eb is Wa, whereas in the case of FIG. 22C, the pulse width of the waveform Ec is Wb. That is, the length of a time period for which the switching TFT is turned ON differs in accordance with the magnitude of the gradation data, so that the light emission quantity of the light emitting element can be changed. In this manner, the exposure quantity for the image carrier can be changed by turning ON and OFF the light emitting element through the ON/OFF control of the switching TFT, and hence, the circuit arrangement can be simplified.

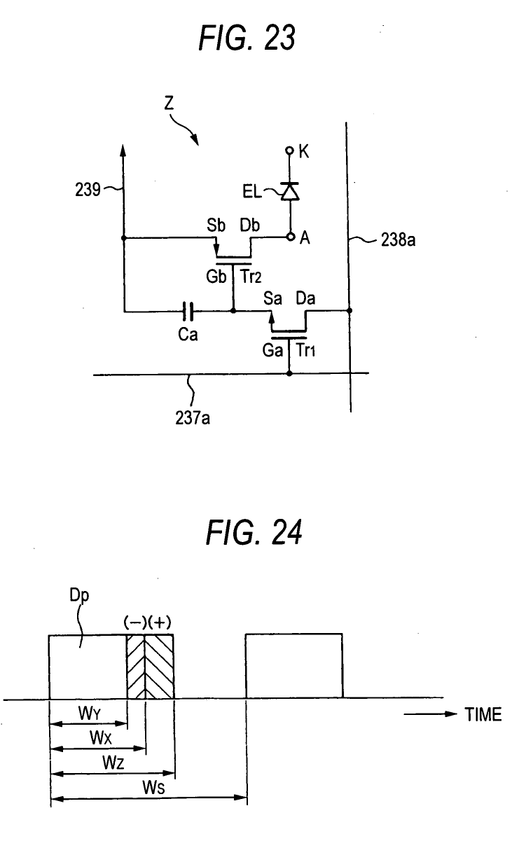

FIG. 23 is a circuit diagram for operating the light emitting portion Z shown in FIG. 21, by an active matrix. Referring to FIG. 23, an organic EL element is used as a light emitting element, and it has a cathode terminal K and an anode terminal A. The cathode terminal K is connected to a power source not shown. Sign 237a designates a scan line, which is connected to the gate Ga of the switching TFT (Tr1). Besides, sign 238a designates a signal line, which is connected to the drain Da of the switching TFT. Numeral 239 designates a power source line, and sign Ca a storage capacitor. The source Sb of a driving TFT (Tr2) for the organic EL element is connected to the power source line 239, and the drain Db thereof to the anode terminal A of the organic EL element. Further, the gate Gb of the driving TFT is connected to the source Sa of the switching TFT.

Next, the operation of the circuit diagram in FIG. 23 will be described. When the scan line 237a and the signal line 238a are energized in a state where the voltage of the power source line 239 is applied to the source of the switching TFT, this switching TFT turns ON. Therefore, the gate voltage of the driving TFT lowers, the voltage of the power source 239 is fed through the source of the driving TFT, and this driving TFT is rendered conductive. As a result, the organic EL element operates to emit light in a predetermined light quantity. Besides, the storage capacitor Ca is charged by the voltage of the power source line 239.

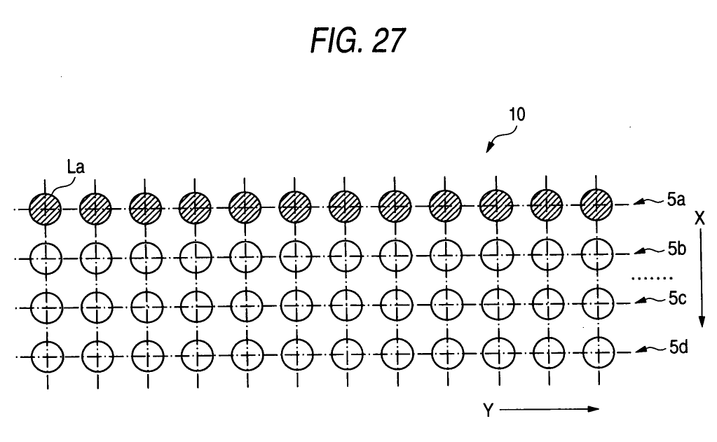

FIG. 27 is an explanatory diagram showing a third embodiment of the invention. Referring to FIG. 27, a line head 10 is formed with a light emitting element line 5a at which a large number of light emitting elements La are arrayed at one line in a main scan direction (Y-direction). A plurality of such light emitting element lines 5a-5d are disposed in a sub-scan direction (X-direction). The control of the line head as shown in FIG. 27 proceeds as stated below, in the block diagrams of FIGS. 1 and 13.

When image data from the main controller 7 is inputted to the control unit 1, the individual light emitting elements of the light emitting element line 5a are actuated by the operation of the drive circuit 4 to expose pixels on an image carrier to light in predetermined light quantities on the basis of gradation data. The image carrier is driven to rotate and to move in the X-direction indicated by an arrow, until the pixels exposed to the light by the light emitting elements of the first light emitting element line 5a reach the positions of the light emitting elements arrayed at the next light emitting element line 5b. Image data are outputted to the light emitting elements of the light emitting element line 5b, and the individual light emitting elements are lit up on the basis of the gradation data. Therefore, the pixels exposed to the light by the light emitting elements of the light emitting element line 5a at the last time are exposed to the light again in the light quantities of the same intensities by the light emitting elements of the light emitting element line 5b.

In this way, while the image carrier is being moved in the X-direction indicated by the arrow, the same pixels are successively exposed to the light in multiple fashion by the different light emitting element lines in the sub-scan direction. In the example of FIG. 27, therefore, each pixel is subjected to the multiple exposure in a light quantity which is quadruple larger than in a case where it is exposed to the light by the single light emitting element, and a light quantity which is necessary for the exposure of each pixel to the light can be acquired at high speed. The image data are fed to each light emitting element line in such a way that the control circuit 2 is provided with a shift register, and that the image data are shifted to the shift register in synchronism with the movement of the image carrier in the sub-scan direction.

In case of performing the gradation control of intermediate density in the construction of FIGS. 1 and 13, when a predetermined brightness is set at 1 (one) by way of example, image data having a brightness of 0.1 is inputted from the main controller 7 to the control unit 1. Owing to the processing as stated above in which, while the image carrier is being moved, the image data is successively shifted to the shift register and then outputted to the light emitting element, the brightness of one pixel becomes 0.1×4=0.4, and the intermediate density is obtained. In this way, a gradation output in the case of exposing the pixel to light is obtained. In this manner, according to the invention, even in the line head which performs the multiple exposure, the dispersion of light quantities can be suppressed to prevent an image quality from degrading.

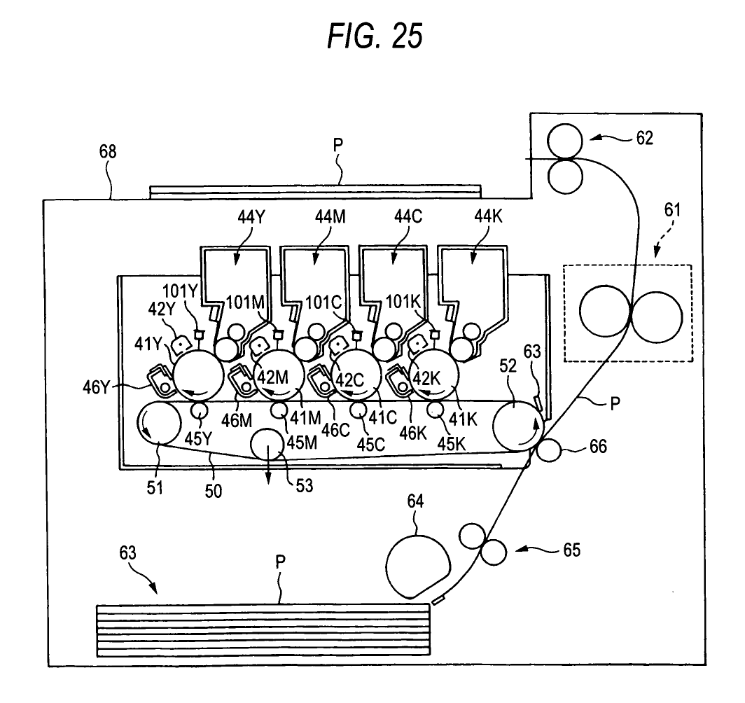

In the invention, the organic EL array head constructed as described above can be employed as the exposure head of an image formation apparatus which forms a color image of, for example, electrophotographic scheme. FIG. 25 is a front view showing an example of the image formation apparatus which employs the organic EL array head. The image formation apparatus is such that four organic EL array exposure heads 101K, 101C, 101M and 101Y of similar constructions are respectively arranged at the exposure positions of four corresponding photosensor drums (image carriers) 41K, 41C, 41M and 41Y of similar constructions. It is constructed as an image formation apparatus of tandem scheme.

As shown in FIG. 25, the image formation apparatus is provided with a driving roller 51, a driven roller 52 and a tension roller 53. It includes an intermediate transfer belt 50 which is tensioned and extended by the tension roller 53, and which is circularly driven in a direction indicated by arrows (in a counterclockwise direction). Arranged for the intermediate transfer belt 50 are the four photosensors 41K, 41C, 41M and 41Y being the image carriers, which are located at predetermined intervals and which have photosensitive layers at its outer peripheral surfaces.

Letters K, C, M and Y affixed to the reference signs signify black, cyan, magenta and yellow, respectively, and the reference signs designate the photosensors for black, cyan, magenta and yellow, respectively. The same holds true also of other members. The photosensors 41K, 41C, 41M and 41Y are driven to rotate in a direction indicated by arrows (in a clockwise direction), in synchronism with the drive of the intermediate transfer belt 50.

Disposed around the photosensors 41 (K, C, M and Y) are charging units (corona chargers) 42 (K, C, M and Y) which uniformly charge the outer peripheral surfaces of the respective photosensors 41 (K, C, M and Y), and the organic EL array exposure heads 101 (K, C, M and Y) of the invention as stated above, which successively performs the line scans of the outer peripheral surfaces uniformly charged by the charging units 42 (K, C, M and Y), in synchronism with the rotations of the respective photosensors 41 (K, C, M and Y).

Besides, the image formation apparatus includes developing devices 44 (K, C, M and Y) by which toner being a developing agent is given to electrostatic latent images formed by the organic EL array exposure heads 101 (K, C, M and Y), thereby to form visible images (toner images), primary transfer rollers 45 (K, C, M and Y) being a transfer unit, by which the toner images developed by the developing devices 44 (K, C, M and Y) are successively transferred onto the intermediate transfer belt 50 being a subject for primary transfer, and cleaning devices 46 (K, C, M and Y) being a cleaning unit, which remove the toner that remains on the surfaces of the photosensors 41 (K, C, M and Y) after the transfer operations.

Here, the respective organic EL array exposure heads 101 (K, C, M and Y) have their array directions set so as to extend along the buses of the corresponding photosensor drums 41 (K, C, M and Y). Besides, the respective organic EL array exposure heads 101 (K, C, M and Y) have their light emission energy peak wavelengths set so as to substantially agree with the sensitivity peak wavelengths of the corresponding photosensors 41 (K, C, M and Y).

The developing devices 44 (K, C, M and Y) employ, for example, a nonmagnetic single-component toner as the developing agent. The latent images are developed as the toner images in such a way that the single-component toner is conveyed onto developing rollers by feed rollers by way of example, that the films of the developing agent adhering on the surfaces of the developing rollers have their thicknesses regulated by regulation blades, and that the developing rollers are touched with or pressed against the photosensors 41 (K, C, M and Y), whereby the developing agent is caused to adhere in accordance with the potential levels of the photosensors 41 (K, C, M and Y).

The toner images of black, cyan, magenta and yellow formed by such monochromatic-toner-image formation stations of the four colors are primarily transferred onto the intermediate transfer belt 50 in succession by primary transfer biases which are applied to the primary transfer rollers 45 (K, C, M and Y), and they are successively superposed on one another on the intermediate transfer belt 50, into a full-color toner image. This full-color toner image is secondarily transferred onto a record medium, such as paper, P at the position of a secondary transfer roller 66, and it is fixed onto the record medium P by passing through a pair of fixing rollers 61 which constitute a fixing unit. The record medium P bearing the toner image is ejected onto a paper ejection tray 68 formed at the upper part of the apparatus, by a pair of paper ejection rollers 62.

By the way, in FIG. 25, numeral 63 designates a paper feed cassette in which a large number of sheets of record medium P are stacked and held, numeral 64 a pickup roller which feeds the sheets of record medium P one by one from the paper feed cassette 63, numeral 65 a pair of gate rollers which stipulate the timing of the secondary transfer roller 66 for feeding the record medium P to a secondary transfer section, numeral 66 the secondary transfer roller being a secondary transfer unit, which forms the secondary transfer section between it and the intermediate transfer belt 50, and numeral 67 a cleaning blade being a cleaning unit, which removes the toner remaining on the surface of the intermediate transfer belt 50 after the secondary transfer.

In this manner, the image formation apparatus in FIG. 25 employs the organic EL array as a write unit, and hence, it can be made smaller in size than in case of employing a laser scan optical system. According to the invention, in the image formation apparatus of tandem scheme as shown in FIG. 25, the dispersion of light quantities in a main scan direction can be suppressed to prevent an image quality from degrading.

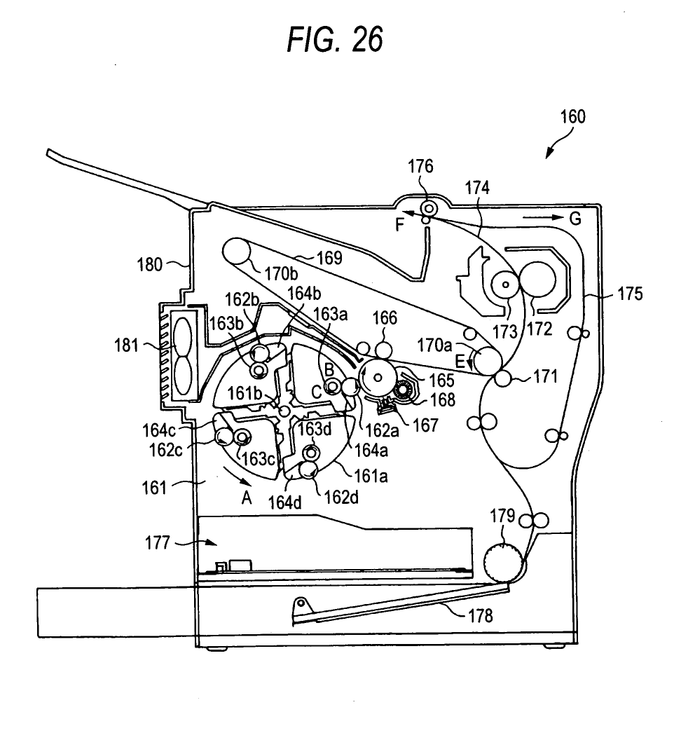

Next, a fourth embodiment of an image formation apparatus according to the invention will be described. FIG. 26 is a vertical sectional side view of the image formation apparatus. Referring to FIG. 26, the image formation apparatus 160 is provided as principal constituent members with a developing device 161 of rotary construction, a photosensor drum 165 which functions as an image carrier, an image write unit (a line head) 167 which includes an organic EL array, an intermediate transfer belt 169, a paper conveyance path 174, the heating roller 172 of a fixing unit, and a paper feed tray 178.

The developing device 161 is such that a developing rotary member 161a rotates in a direction indicated by an arrow A, about a shaft 161b. The interior of the developing rotary member 161a is divided into four parts, in which image formation units in the four colors of yellow (y), cyan (C), magenta (M) and black (K) are respectively disposed. Signs 162a-162d designate developing rollers which are arranged in the respective image formation units of the four colors and which rotate in a direction indicated by an arrow B, while signs 163a-163d designate toner feed rollers which rotate in a direction indicated by an arrow C. Besides, signs 164a-164d designate regulation blades which regulates toner to a predetermined thickness.

Numeral 165 designates the photosensor drum which functions as the image carrier as stated above, numeral 166 designates a primary transfer member, numeral 168 designates a charger, and numeral 167 designates the image write unit which includes the organic EL array. The photosensor drum 165 is driven in a direction indicated by an arrow D, reverse to the direction of the developing roller 162a, by a driving motor, for example, a step motor, not shown.

The intermediate transfer belt 169 is extended between a driven roller 170b and a driving roller 170a. The driving roller 170a is connected to the driving motor of the photosensor drum 165, and it transmits power to the intermediate transfer belt 169. Owing to the drive of the driving motor, the driving roller 170a of the intermediate transfer belt 169 is turned in a direction indicated by an arrow E, reverse to the direction of the photosensor drums 165.

The paper conveyance path 174 includes a plurality of conveyance rollers, a pair of paper ejection rollers 176, etc., which convey paper. A one-side image (toner image) borne on the intermediate transfer belt 169 is transferred onto one surface of the paper at the position of a secondary transfer roller 171. The secondary transfer roller 171 is brought into and out of touch with the intermediate transfer belt 169 by a clutch, and it is touched with the intermediate transfer belt 169 by clutch-ON, whereby the image is transferred onto the paper.

The paper onto which the image has been transferred in the above way is subsequently subjected to a fixing process by the fixing unit which has a fixing heater H. The fixing unit is provided with the heating roller 172 and a press roller 173. The paper after the fixing process is pulled in between the pair of paper ejection rollers 176, and it proceeds in a direction indicated by an arrow F. When the pair of paper ejection rollers 176 rotate reversely from this state, the paper has its proceeding direction inverted, and it proceeds in a direction indicated by an arrow G, along a dual-side printing conveyance path 175. Numeral 177 designates an electronic-component box, numeral 178 the paper feed tray in which the sheets of paper are accommodated, and numeral 179 a pickup roller which is disposed at the outlet of the paper feed tray 178.

In the paper conveyance path, a brushless motor of low speed, for example, is employed as a driving motor which drives the conveyance rollers. Besides, since the intermediate transfer belt 169 necessitates a color misregistration correction, etc., a step motor is employed therefor. These motors are controlled by signals from control unit not shown.

In the illustrated state, an electrostatic latent image of yellow (Y) is formed on the photosensor drum 165, and a high voltage is applied to the developing roller 162a, whereby the yellow image is formed on the photosensor drum 165. When all yellow images on a rear side and a front side have been borne on the intermediate transfer belt 169, the developing rotary member 161a is rotated 90 degrees in the direction of the arrow A.

The intermediate transfer belt 169 returns to the position of the photosensor drum 165 by effecting one revolution. Subsequently, dual-side images of cyan (C) are formed on the photosensor drum 165, and they are borne in superposition on the yellow images borne on the intermediate transfer belt 169. Thenceforth, the 90-degree rotation of the developing rotary member 161a and the one-revolution process of the intermediate transfer belt 169 after bearing the images are iterated similarly to the above.

The intermediate transfer belt 169 effects four revolutions in order to bear the color image in the four colors, whereupon it has its rotational position further controlled so as to transfer the image onto the paper at the position of the secondary transfer roller 171. The paper fed from the paper feed tray 178 is conveyed along the conveyance path 174, and the color image is transferred onto one surface of the paper at the position of the secondary transfer roller 171. The paper onto one surface of which the image has been transferred, has its proceeding direction inverted by the pair of paper ejection rollers 176 as stated before and stands by on the conveyance path 175. Thereafter, the paper is conveyed to the position of the secondary transfer roller 171 at an appropriate timing, and the color image is transferred onto the other surface of the paper. A housing 180 is provided with an exhaust fan 181. According to the invention, in the image formation apparatus of rotary scheme as shown in FIG. 26, the dispersion of light quantities in a main scan direction can be suppressed to prevent an image quality from degrading. Besides, in an image formation apparatus of tandem scheme or rotary scheme including an intermediate transfer member, the dispersion of light quantities in a main scan direction can be suppressed to prevent an image quality from degrading.

Thus far, the line head and the image formation apparatus of the invention have been described in conjunction with the embodiments. The line head and the image formation apparatus of the invention are not restricted to the embodiments, but they are capable of various modifications.

As described above, according to the invention, in a case where a plurality of light emitting elements are arrayed at one line and are operated to light up, it is possible to provide a line head which is constructed so as to have no dispersion in light quantities in a main scan direction, and an image formation apparatus which employs the line head.

The present application is based on Japan Patent Application Nos. 2004-038029 and 2004-038030 filed on Feb. 16, 2004, the contents of which are incorporated herein for reference.

1. A line head, comprising:
a plurality of light emitting elements, which are arranged in a line; and
a controller, which applies constant voltage to the light emitting elements on the basis of gradation data,
wherein correction data for correcting a dispersion of light quantities of the respective light emitting elements are added to the gradation data.

2. A line head, comprising:
a plurality of light emitting elements, which are arranged in a line; and
a controller, which applies constant voltage to the light emitting elements on the basis of gradation data,
wherein correction data of electric quantity for correcting a dispersion of light quantities of the respective light emitting elements are formed by the gradation data.

3. The line head as set forth in claim 1, further comprising a setting unit which sets the correction data,
wherein the setting unit and the light emitting elements are provided on the same substrate.

4. The line head as set forth in claim 2, further comprising a setting unit which sets the correction data,
wherein the setting unit and the light emitting elements are provided on the same substrate.

5. The line head as set forth in claim 1, wherein the correction data are set for the respective light emitting elements in accordance with deviation amounts of the light emission quantities with respect to a reference light quantity.

6. The line head as set forth in claim 2, wherein the correction data are set for the respective light emitting elements in accordance with deviation amounts of the light emission quantities with respect to a reference light quantity.

7. The line head as set forth in claim 3, wherein the correction data are stored in the setting unit together with the gradation data in a table format.

8. The line head as set forth in claim 4, wherein the correction data are stored in the setting unit together with the gradation data in a table format.

9. The line head as set forth in claim 1, wherein the light emitting elements are configured by organic EL elements.

10. The line head as set forth in claim 2, wherein the light emitting elements are configured by organic EL elements.

11. The line head as set forth in claim 1, wherein the controller is configured by a drive circuit of active matrix scheme which controls the light emitting elements.

12. The line head as set forth in claim 2, wherein the controller is configured by a drive circuit of active matrix scheme which controls the light emitting elements.

13. The line head as set forth in claim 1, wherein the light quantity control of the light emitting elements is performed by a PWM control.

14. The line head as set forth in claim 2, wherein the electric quantity is voltage or current.

15. The line head as set forth in claim 1, wherein a plurality of linear arrays of light emitting elements in which each of the linear arrays has the light emitting elements; and
wherein the linear arrays of the light emitting elements are arranged in a sub-scan direction of the line head.

16. The line head as set forth in claim 2, wherein a plurality of linear arrays of light emitting elements in which each of the linear arrays has the light emitting elements; and
wherein the linear arrays of the light emitting elements are arranged in a sub-scan direction of the line head.

17. An image formation apparatus, comprising:
at least two image forming stations, each including:
an image carrier;
a charger, which charges the image carrier, and is located near the image carrier;
a line head according to any one of claims 1 through 16 for exposing the image carrier; and
an image transfer, which transfer a toner image to a transfer medium,
wherein the transfer medium is passed through the individual image forming stations so that image formation is performed by a tandem scheme.

18. An image formation apparatus, comprising:
an image carrier, which is configured so as to bear an electrostatic latent image;
a rotary developing unit; and
a line head according to any one of claims 1 through 16 for exposing the image carrier,
wherein the rotary developing unit bears toners which is accommodated in a plurality of toner cartridges, on its surface, and rotates in a predetermined rotating direction so as to successively convey the toners of different colors to a position opposing to the image carrier; and
wherein the rotary developing unit applies developing bias between the image carrier and the rotary developing unit so that the toners are moved from the rotary developing unit to the image carrier, whereby the electrostatic latent images are developed to form a toner image.

19. The image formation apparatus as set forth in claim 17 further comprising an intermediate transfer member.

20. The image formation apparatus as set forth in claim 18 further comprising an intermediate transfer member.
